(19) United States
(12) Patent Application Publication
(10) Pub. No.: US 2026/0364450 A1
(43) Pub. Date: Nov. 19, 2026

(54) PROCESSING METHOD AND APPARATUS FOR OBSERVATION PICTURE, DEVICE, AND STORAGE MEDIUM

(71) Applicant: Tencent Technology (Shenzhen) Company Limited, Shenzhen (CN)

(72) Inventors: Yijun HE, Shenzhen (CN); Yusheng MAO, Shenzhen (CN)

(21) Appl. No.: 19/728,103

(22) Filed: Jul. 1, 2026

Related U.S. Application Data
(63) Continuation of application No. PCT/CN2025/087669, filed on Apr. 8, 2025.

(30) Foreign Application Priority Data
May 22, 2024 (CN) 202410642441.5

(51) Int. Cl. A63F 13/5252; A63F 13/5372; A63F 13/822; A63F 13/837

(52) U.S. Cl. CPC A63F 13/5252; A63F 13/5372; A63F 13/822; A63F 13/837

(57) ABSTRACT

This application discloses a method for generating an observation picture of a virtual environment performed by a computer device. The method includes: generating a first observation picture of a first region in the virtual environment by using a first virtual camera located at a first height in the virtual environment for a first screen of a first terminal having a first aspect ratio; and generating a second observation picture of a second region in the virtual environment by using a second virtual camera located at a first height in the virtual environment for a second screen of a second terminal having a second aspect ratio, the first aspect ratio being greater than the second aspect ratio, and the first height being less than the second height.

### CROSS-REFERENCE TO RELATED APPLICATIONS

This application is a continuation application of PCT Patent Application No. PCT/CN2025/087669, entitled “PROCESSING METHOD AND APPARATUS FOR OBSERVATION PICTURE, DEVICE, AND STORAGE MEDIUM” filed on Apr. 8, 2025, which claims priority to Chinese Patent Application No. 202410642441.5, entitled “PROCESSING METHOD AND APPARATUS FOR OBSERVATION PICTURE, DEVICE, AND STORAGE MEDIUM” filed on May 22, 2024, both of which are incorporated by reference in their entirety.

### FIELD OF THE TECHNOLOGY

This application relates to the field of human-computer interaction technologies, and in particular, to a processing method and apparatus for an observation picture, a device, and a storage medium.

### BACKGROUND OF THE DISCLOSURE

In an application providing a virtual environment, a virtual character usually needs to be controlled to perform activities in the virtual environment, such as walking, driving, climbing, and picking up items.

In the related art, a virtual camera is deployed in the virtual environment, to observe the virtual environment, and an imaging picture of the virtual camera is displayed on a terminal as an observation picture of the virtual environment, to present an appearance of the virtual environment to a user.

However, there are various types of terminals, and aspect ratios of screens of the terminal are also different. How to ensure that the observation picture of the virtual environment displayed on the screens having different aspect ratios has a similar field of view value is an urgent problem to be resolved.

### SUMMARY

This application provides a processing method and apparatus for an observation picture, a device, and a storage medium. The technical solutions are as follows.

According to an aspect of this application, a method for generating an observation picture of a virtual environment is performed by a computer device, and the method includes:
generating a first observation picture by using a first virtual camera located at a first height in the virtual environment for a first screen of a first terminal having a first aspect ratio, the first observation picture being an observation result of a first region in the virtual environment, and an area of the first region in the virtual environment being a first area; and
generating a second observation picture by using a second virtual camera located at a first height in the virtual environment for a second screen of a second terminal having a second aspect ratio, the second observation picture being an observation result of a second region in the virtual environment, and an area of the second region in the virtual environment being a second area, wherein:
a ratio between the first aspect ratio and the second aspect ratio being a first ratio, a ratio between the first area and the second area being a second ratio, and the first ratio being greater than the second ratio; and the first aspect ratio being greater than the second aspect ratio, and the first height being less than the second height.

According to another aspect of this application, a computer device is provided. The computer device includes a processor and a memory, the memory having at least one instruction, at least one segment of program, a code set, or an instruction set stored therein, and the at least one instruction, the at least one segment of program, the code set, or the instruction set, when being loaded and executed by the processor, implementing the method for generating an observation picture of a virtual environment according to the foregoing aspect.

According to another aspect of this application, a non-transitory computer-readable storage medium is provided. The computer-readable storage medium has at least one instruction, at least one segment of program, a code set, or an instruction set stored therein, the at least one instruction, the at least one segment of program, the code set, or the instruction set, when being loaded and executed by a processor, implementing the method for generating an observation picture of a virtual environment according to the foregoing aspect.

Beneficial effects of the technical solutions provided in this application at least include:

The first region in the virtual environment is displayed in the first screen having the first aspect ratio, the second region in the virtual environment is displayed in the second screen having the second aspect ratio, and the first ratio between the aspect ratio of the first screen and the aspect ratio of the second screen is constrained to be greater than the ratio between the area of the first region and the area of the second region, so that a difference in corresponding areas in the virtual environment of pictures displayed on screens with different aspect ratios is reduced, thereby reducing a difference in field of view values of observation pictures displayed on the screens with different aspect ratios, balancing human-computer interaction efficiency when displaying the observation pictures of the virtual environment on the screens with different aspect ratios, and ensuring fairness of performing virtual competition in the virtual environment.

### BRIEF DESCRIPTION OF THE DRAWINGS

FIG. 1 is a block diagram of a structure of a computer system according to an exemplary embodiment of this application.

FIG. 2 is a schematic diagram of an observation picture according to an exemplary embodiment of this application.

FIG. 3 is a schematic diagram of a processing method for an observation picture according to an exemplary embodiment of this application.

FIG. 4 is a flowchart of a processing method for an observation picture according to an exemplary embodiment of this application.

FIG. 5 is a flowchart of a processing method for an observation picture according to an exemplary embodiment of this application.

FIG. 6 is a flowchart of a processing method for an observation picture according to an exemplary embodiment of this application.

FIG. 7 is a schematic diagram of an observation picture according to an exemplary embodiment of this application.

FIG. 8 is a schematic diagram of a visual weight according to an exemplary embodiment of this application.

FIG. 9 is a flowchart of a processing method for an observation picture according to an exemplary embodiment of this application.

FIG. 10 is a flowchart of a processing method for an observation picture according to an exemplary embodiment of this application.

FIG. 11 is a block diagram of a structure of a processing apparatus for an observation picture according to an exemplary embodiment of this application.

FIG. 12 is a block diagram of a structure of a terminal according to an exemplary embodiment of this application.

### DESCRIPTION OF EMBODIMENTS

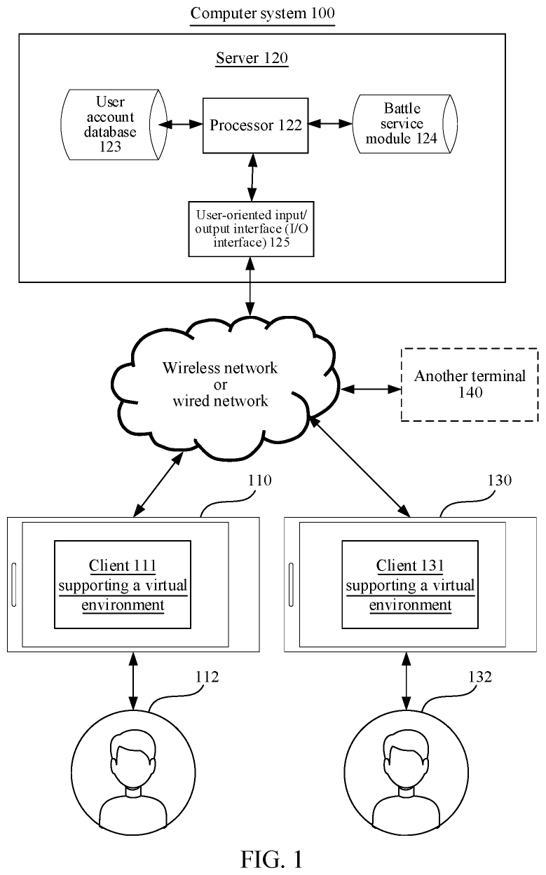

FIG. 1 is a block diagram of a structure of a computer system according to an exemplary embodiment of this application. A computer system 100 includes a first terminal 110, a server 120, and a second terminal 130.

A client 111 supporting a virtual environment is installed and run on the first terminal 110. The client 111 may be a multiplayer online battle program. When the first terminal runs the client 111, a user interface of the client 111 is displayed on a screen of the first terminal 110. The client 111 may be any one of a battle royale shooting game, a virtual reality (VR) application, an augmented reality (AR) program, a three-dimensional map program, a virtual reality game, an augmented reality game, a first-person shooting game (FPS), a third-personal shooting game (TPS), a multiplayer online battle arena (MOBA) game, a simulation game (SLG), or a real-time strategy game (RTS). In this embodiment, an example in which the client 111 is an FPS game is used for description. The first terminal 110 is a terminal used by a first user 112. The first user 112 controls, by using the first terminal 110, a first virtual character located in the virtual environment to perform an activity. The first virtual character may be referred to as a virtual character of the first user 112. The activity of the first virtual character includes, but is not limited to, at least one of moving, jumping, teleporting, releasing a skill, using an item, adjusting a body posture, crawling, walking, running, riding, flying, jumping, driving, picking up, shooting, attacking, or throwing. Exemplarily, the first virtual character is a first virtual character, for example, a simulated human character role or an anime character.

A client 131 supporting the virtual environment is installed and run on the second terminal 130. The client 131 may be the multiplayer online battle program. When the second terminal 130 runs the client 131, a user interface of the client 131 is displayed on a screen of the second terminal 130. The client may be any one of a battle royale shooting game, a VR application, an AR application, a three-dimensional map program, a virtual reality game, an augmented reality game, an FPS, a TPS, a MOBA, an SLG, or an RTS. In this embodiment, an example in which the client is the MOBA game is used for description. The second terminal 130 is a terminal used by a second user 132. The second user 132 controls, by using the second terminal 130, a second virtual character located in the virtual environment to perform an activity. The second virtual character may be referred to as a virtual character of the second user 132. Exemplarily, the second virtual character is a second virtual character, for example, a simulated human character or an anime character.

In one embodiment, the first virtual character and the second virtual character are in the same virtual environment. In one embodiment, the first virtual character and the second virtual character may belong to the same faction, the same team, the same organization, have a friend relationship, or have temporary communication permissions. In one embodiment, the first virtual character and the second virtual character may belong to different factions, different teams, different organizations, or have an adversarial relationship.

In one embodiment, clients installed on the first terminal 110 and the second terminal 130 are the same, or clients installed on the two terminals are clients of the same type on different operating system platforms (Android or IOS). The first terminal 110 may be one of a plurality of terminals, and the second terminal 130 may be another one of the plurality of terminals. In this embodiment, only the first terminal 110 and the second terminal 130 are used as an example for description. Device types of the first terminal 110 and the second terminal 130 are the same or different. The device type includes at least one of a smart phone, a tablet computer, an e-book reader, an MP3 player, an MP4 player, a laptop portable computer, and a desktop computer.

Only two terminals are shown in FIG. 1, but a plurality of other terminals 140 may access the server 120 in different embodiments. In one embodiment, one or more terminals 140 are further terminals corresponding to a developer. A development and editing platform of a client supporting the virtual environment is installed on the terminal 140. The developer may edit and update the client on the terminal 140, and transmit an updated client installation package to the server 120 via a wired or wireless network. The first terminal 110 and the second terminal 130 may download the client installation package from the server 120 to implement updating the client.

The first terminal 110, the second terminal 130, and the another terminal 140 are connected to the server 120 via the wireless network or wired network.

The server 120 includes at least one of one server, a plurality of servers, a cloud computing platform, and a virtualization center. The server 120 is configured to providing a background service for a client supporting a three-dimensional virtual environment. In one embodiment, the server 120 takes main computing work, and the terminal takes secondary computing work. Alternatively, the server 120 takes the secondary computing work and the terminal takes the main computing work. Alternatively, the server 120 and the terminal perform cooperative computing by using a distributed computing architecture.

In an exemplary example, the server 120 includes a processor 122, a user account database 123, a battle service module 124, and a user-oriented input/output interface (I/O interface) 125. The processor 122 is configured to load an instruction stored in the server 121, and process data in the user account database 123 and the battle service module 124. The user account database 123 is configured for storing data of user accounts used by the first terminal 110, the second terminal 130, and the another terminal 140, such as avatars of the user accounts, nicknames of the user accounts, fighting power indices of the user accounts, and service regions of the user accounts. The battle service module 124 is configured to provide a plurality of battle rooms for the user to conduct a battle, such as a 1V1 battle, a 3V3 battle, and a 5V5 battle. The user-oriented I/O interface 125 is configured to establish communication and exchange data with the first terminal 110 and/or the second terminal 130 via the wireless network or wired network.

The method provided in this application may be applied to, but is not limited to, at least one of the following scenarios: a virtual reality application, a three-dimensional map program, a first-person shooting game (FPS), a third-person shooting game (TPS), a multiplayer online battle arena game (MOBA), a multiplayer shooting survival game, or the like. The following embodiment in a game is used as an example for description.

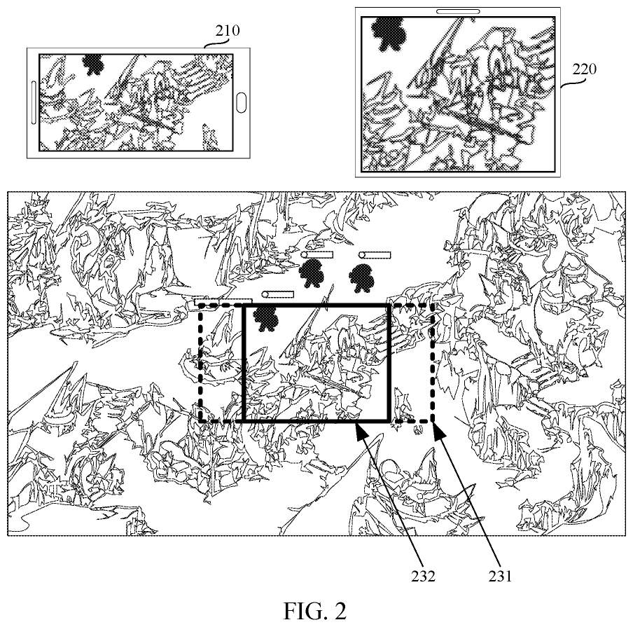

FIG. 2 is a schematic diagram of an observation picture according to an exemplary embodiment of this application.

In this embodiment, a first aspect ratio of a first screen 210 is 2:1, and a second aspect ratio of a second screen 220 is 5:4. For example, the first screen 210 is a screen of a smart phone terminal, and the second screen 220 is a screen of an external display of a personal computer.

In the related art, a first observation picture displayed in the first screen 210 is an observation result of an initial region 231 in a virtual environment. A second observation picture displayed in the second screen 220 is an observation result of a cropped region 232 in the virtual environment.

A ratio between the first aspect ratio and the second aspect ratio is a first ratio, that is, a ratio between 2 and 1.25, which is equal to 1.6.

In the related art, it is necessary to ensure that a ratio of areas in the virtual environment corresponding to the observation pictures displayed on the two screens is equal to the first ratio (that is, 1.6) as shown in FIG. 2. The cropped region 232 is obtained by cropping the initial region 231. A strip-shaped region is cropped from each of a left side and a right side of the initial region 231, to obtain the cropped region 232 having a width equal to that of the initial region 231 and an aspect ratio of the second aspect ratio. As a result, terminals having different aspect ratios display different areas of information in the virtual environment, in other words, the aspect ratio of the screen is directly proportional to an area of the displayed observation picture in the virtual environment. Further, when a player uses screens having different aspect ratios, different fields of view of the displayed observation picture in the virtual environment are displayed. When the player uses a screen having a large aspect ratio, a large field of view of the observation picture is displayed Consequently, a first user using a screen having a larger aspect ratio has higher observation efficiency of the virtual environment than a second user using a screen having a smaller aspect ratio, and obtains more information presented visually in the virtual environment, leading to unfairness in virtual competition in the virtual environment.

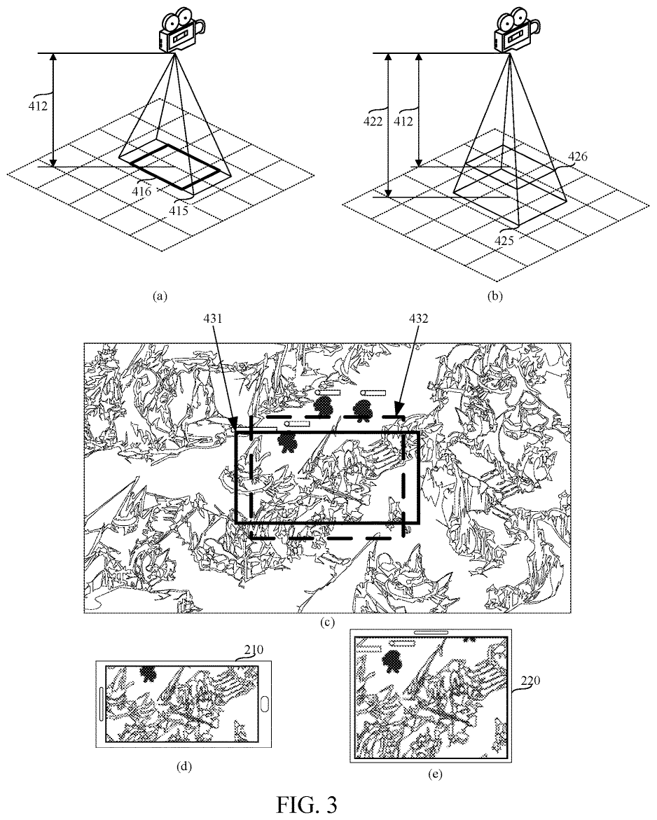

FIG. 3 is a schematic diagram of a processing method for an observation picture according to an exemplary embodiment of this application. In this embodiment, a virtual environment is observed by using a virtual camera deployed in the virtual environment. Grids shown in sub-figure (a) and sub-figure (b) in a dashed manner are horizontal planes of the virtual environment.

As shown in sub-figure (a), a schematic diagram of the virtual camera observing the virtual environment at a first height 412 at a top view is shown. A first observation picture obtained by the virtual camera at the first height 412 matches a first screen 210 having a first aspect ratio in sub-figure (d), and a region corresponding to the first observation picture in the virtual environment is a first region 415. An aspect ratio of the first region is the same as the first aspect ratio of the first screen (such as 2:1).

For a second screen having a second aspect ratio, the first aspect ratio (such as 5:4) is greater than the second aspect ratio, if the virtual camera maintains the first height 412 unchanged (that is, a display manner in the related art described in FIG. 2), an obtained observation picture is referred to as an equal-height observation picture, corresponding to a corrected region 416 in the virtual environment. The corrected region is shown in sub-figure (a) in a bold frame manner to distinguish from the first region 415. In sub-figure (a), the first aspect ratio is greater than the second aspect ratio, and a ratio between the first aspect ratio and the second aspect ratio is a first ratio. A ratio between an area of the first region 415 and an area of the corrected region 416 is equal to the first ratio.

As shown in sub-figure (b), a schematic diagram of the virtual camera observing the virtual environment at a second height 422 (where the second height 422 is greater than the first height 412) at a top view is shown. A second observation picture obtained by the virtual camera at the second height 422 matches a second screen 220 having the second aspect ratio in sub-figure (e), and a region corresponding to the second observation picture in the virtual environment is a second region 425. An aspect ratio of the second region is the same as the second aspect ratio of the second screen (such as 5:4).

When the virtual camera observes the virtual environment, a viewing frustum is formed. As shown in sub-figure (b), the viewing frustum is a quadrangular pyramid having the second region 425 as a base and a position of the virtual camera as a vertex. At a distance of the first height 412 from the position of the virtual camera, a cross-section 426 of the foregoing viewing frustum is a rectangle having the second aspect ratio, and a size of the rectangle is the same as an area of the corrected region 416 in sub-figure (a). Because the observation picture obtained by the camera model conforms to a human eye observation rule of “objects appear larger when closer and smaller when farther”. An area of the second region 425 is greater than the area of the corrected region 416.

Sub-figure (c) is a schematic diagram of the virtual environment at the top view. A style in which the first region 415 in sub-figure (a) is displayed on the screen having the first aspect ratio is a first part 431 in sub-figure (c). A style in which the second region 425 in sub-figure (b) is displayed on the screen having the second aspect ratio is a second part 432 in sub-figure (c). In the virtual environment, a center point of the first part 431 is the same as a center point of the second part 432, but the second part 432 is not obtained by cropping the first part 431.

A ratio between the area of the first region 415 and the area of the second region 425 is a second ratio. Because the area of the second region 425 is greater than the area of the corrected region 416, the second ratio is less than the first ratio, in other words, the first ratio is greater than the second ratio. In other words, when the first aspect ratio is greater than the second aspect ratio, and the first height is less than the second height, it can be ensured that the first ratio is greater than the second ratio, and a difference between areas in the virtual environment of the observation pictures displayed on screens having different aspect ratios is reduced, so that a difference between field of view values of the observation pictures displayed on the screens of different aspect ratios is reduced, thereby balancing human-computer interaction efficiency when displaying the observation pictures of the virtual environment on the screens having different aspect ratios, and improving fairness of executing virtual competition in the virtual environment.

In the following, a processing method for an observation picture is described by using the following embodiment.

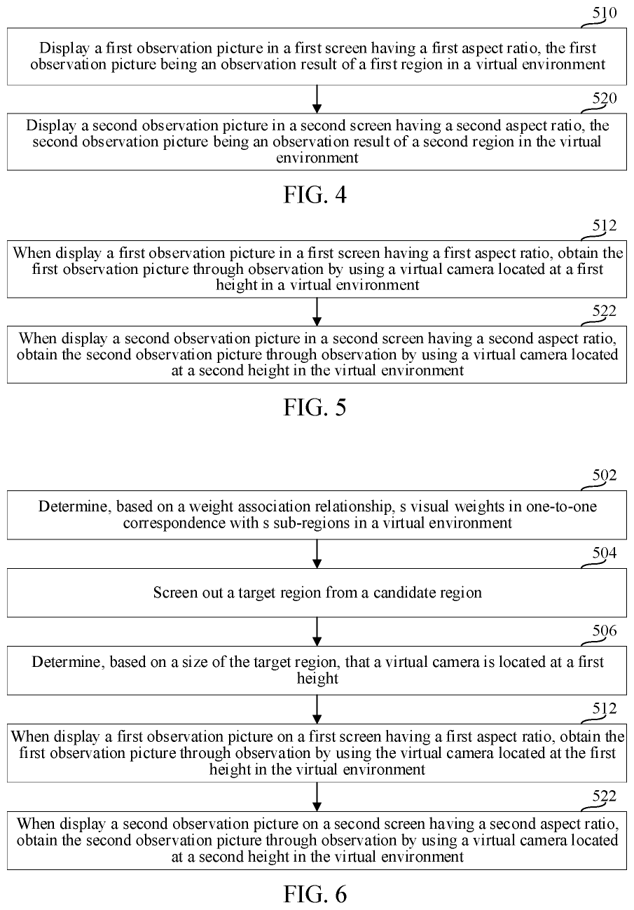

FIG. 4 is a flowchart of a processing method for an observation picture according to an exemplary embodiment of this application. The method may be performed by a computer device such as a terminal or a server. The method includes:

operation 510: Display a first observation picture in a first screen having a first aspect ratio, the first observation picture being an observation result of a first region in a virtual environment. In some embodiments, the computer device generates a first observation picture by using a first virtual camera located at a first height in the virtual environment for a first screen of a first terminal having a first aspect ratio, the first observation picture being an observation result of a first region in the virtual environment, and an area of the first region in the virtual environment being a first area.

Exemplarily, the virtual environment is a virtual space provided for at least one virtual character to perform a virtual activity. For example, the virtual character implements virtual competition by initiating a virtual attack in a virtual match. The virtual environment may be any one of a two-dimensional virtual environment, a 2.5-dimensional virtual environment, and a three-dimensional virtual environment.

Exemplarily, the first observation picture has the same aspect ratio as the first screen, and matches the first screen. Matching between the first observation picture and the first screen is configured for indicating that a part of an edge of the first screen cannot display the observation result of the virtual environment in the first observation picture due to the aspect ratio (also referred to as a black edge appearing at the edge of the first screen) cannot be caused. In a case in which a screen of the terminal is a rounded rectangle, the first aspect ratio is an aspect ratio of a minimum circumscribed rectangle of the rounded rectangle.

The first observation picture is the observation result of the first region in the virtual environment. The first region usually has the same aspect ratio as the first observation picture, but it is not excluded that the aspect ratios of the first region and the first observation picture are different, or even shapes are different. For example, the first observation picture is a result of performing stretching on the observation result of the first region. An area of the first region in the virtual environment is a first area. An area unit of the first area is an area unit in the virtual environment, which may be a unit same as the real world, such as square meter, or may be a parameter of pixel size, such as a quantity of pixels. A representation manner of the first area is not limited in this application. Exemplarily, the first area is an area of a projection of the first observation picture on a virtual horizontal plane in the virtual environment.

Operation 520: Display a second observation picture in a second screen having a second aspect ratio, the second observation picture being an observation result of a second region in the virtual environment. In some embodiments, the computer device generates a second observation picture by using a second virtual camera located at a first height in the virtual environment for a second screen of a second terminal having a second aspect ratio, the second observation picture being an observation result of a second region in the virtual environment, and an area of the second region in the virtual environment being a second area.

Similar to the foregoing description, the second observation picture has the same aspect ratio as the second screen, and matches the second screen. The second observation picture is the observation result of the second region in the virtual environment, and an area of the second region in the virtual environment is a second area.

Exemplarily, a ratio between the first aspect ratio and the second aspect ratio is a first ratio, a ratio between the first area and the second area is a second ratio, and the first ratio is greater than the second ratio. The first screen and the second screen may be different screens of the same terminal, or may be different screens of different terminals. A quantity of terminals performing the processing method for the observation picture and a quantity of screens on one terminal are not limited in this application. Operation 510 may be performed before, after, or simultaneously with operation 520. A time sequence of performing operation 510 and operation 520 is not limited in this application.

In a related art, a virtual environment is observed by using a virtual camera deployed in the virtual environment. In one embodiment, a camera model automatically follows the virtual character in a virtual world, in other words, when a position of the virtual character in the virtual world changes, the camera model changes simultaneously following the position of the virtual character in the virtual world, and the camera model is always in a preset distance range of the virtual character in the virtual world. In one embodiment, a relative position between the camera model and the virtual character does not change in an automatic following process.

Exemplarily, a three-dimensional model in a world space coordinate system is transformed into a camera space coordinate system through a view matrix. The camera space coordinate system is configured for describing a coordinate of the three-dimensional model observed by the camera model, for example, a position of the camera model is used as a coordinate origin. The three-dimensional model in the camera space coordinate system is transformed into a crop space coordinate system through a projection matrix. The crop space coordinate system is configured for describing a projection of the three-dimensional model located in a view frustum of the camera model, and a commonly used perspective projection matrix (a type of projection matrix) is configured for projecting the three-dimensional model to a model conforming to a human eye observation rule of “objects appear larger when closer and smaller when farther” Exemplarily, the foregoing model transformation matrix, view matrix, and projection matrix are usually collectively referred to as a model view projection (MVP) matrix.

Exemplarily, screen sizes of different terminals are different (for example, a common screen size of a tablet computer is 6 inches to 14 inches“, and a common screen size of a mobile phone terminal is 5 inches to 8 inches”). In the related art, for two screens having different screen sizes but the same aspect ratio, areas of displayed observation pictures of the virtual environment in the virtual environment are the same. For example, for a mobile phone terminal and a tablet computer both having an aspect ratio of 16:9, the tablet computer does not display more content of the virtual environment due to a large screen size. Correspondingly, to ensure that the areas of the observation pictures in the virtual environment are the same, a camera height of the virtual camera remains unchanged. As described above, the observation picture obtained through observation by the camera model conforms to the human eye observation rule of “objects appear larger when closer and smaller when farther”. For the two screens having different screen sizes but the same aspect ratio, the camera height remains unchanged, so that it is can be ensured that the area of the observation picture in the virtual environment remains unchanged.

As described in FIG. 2, in the related art, based on an unchanged camera height, for screens having different aspect ratios, the area in the virtual environment corresponding to the observation picture displayed on the screen changes with a change in the aspect ratio of the screen. In other words, the aspect ratio of the screen is directly proportional to the area in the virtual environment corresponding to the displayed observation picture. As a result, terminals having different aspect ratios display different areas of information in the virtual environment, and a player can obtain more information in the virtual environment by using a terminal having a larger aspect ratio screen.

However, in embodiments of this application, a ratio between aspect ratios of different screens is greater than the ratio between the areas of the observation pictures in the virtual environment (that is, the first ratio is greater than the second ratio described above), so that a difference in the areas in the virtual environment of the observation pictures displayed on the screens having different aspect ratios is reduced, thereby balancing human-computer interaction efficiency when displaying the observation pictures of the virtual environment on the screens having different aspect ratios. In some exemplary examples, to further constrain the difference in the areas in the virtual environment corresponding to the observation pictures displayed on the screens having different aspect ratios, the second ratio belongs to a preset range. Exemplarily, the preset range is a preset empirical value, for example, a value of the preset range includes 1. Further, the value of the preset range is less than (or less than or equal to) a and greater than (or greater than or equal to) 1/a. a is an empirical value greater than 1, for example, 1.2. a is configured for indicating a maximum difference ratio of the areas in the virtual environment corresponding to the observation pictures displayed on the screens having different aspect ratios, and the value of a being 1.2 is configured for indicating that the maximum difference ratio of the areas in the virtual environment corresponding to the observation pictures displayed on screens having different aspect ratios is 1.2−1=20%.

In conclusion, in the method provided in this embodiment, the first region in the virtual environment is displayed in the first screen having the first aspect ratio, and the second region in the virtual environment is displayed in the second screen having the second aspect ratio. The first ratio between the aspect ratios of the first screen and the second screen is constrained to be greater than the ratio between the area of the first region and the area of the second region, to reduce the difference in the areas in the virtual environment corresponding to the pictures displayed on the screens having different aspect ratios, so that a difference between field of view values of the observation pictures displayed on the screens of different aspect ratios is reduced, thereby balancing the human-computer interaction efficiency when displaying the observation pictures of the virtual environment on the screens having different aspect ratios, and ensuring fairness of executing virtual competition in the virtual environment.

FIG. 5 is a flowchart of a processing method for an observation picture according to an exemplary embodiment of this application. The method may be performed by a terminal. That is, in the embodiment shown in FIG. 4, operation 510 may be implemented as operation 512, and operation 520 may be implemented as operation 522.

Operation 512: Display a first observation picture in a first screen having a first aspect ratio, and obtain the first observation picture through observation by using a virtual camera located at a first height in a virtual environment. In some embodiments, the display includes generating a first observation picture by using a first virtual camera located at a first height in the virtual environment for a first screen of a first terminal having a first aspect ratio, the first observation picture being an observation result of a first region in the virtual environment, and an area of the first region in the virtual environment being a first area.

As described above, the virtual environment is observed by using the virtual camera deployed in the virtual environment. An example in which the virtual camera observes the virtual environment at a top view is used for description in this embodiment. Exemplarily, when the virtual camera observes the virtual environment at the top view, an aspect ratio of a first region displayed in a first display picture is the same as the first aspect ratio of the first screen.

Operation 522: Display a second observation picture in a second screen having a second aspect ratio, and obtain the second observation picture through observation by using a virtual camera located at a second height in the virtual environment. In some embodiments, the display includes generating a second observation picture by using a second virtual camera located at a first height in the virtual environment for a second screen of a second terminal having a second aspect ratio, the second observation picture being an observation result of a second region in the virtual environment, and an area of the second region in the virtual environment being a second area.

Similarly, exemplarily, when the virtual camera observes the virtual environment at the top view, an aspect ratio of a second region displayed in a second display picture is the same as the second aspect ratio of the second screen. The first aspect ratio is greater than the second aspect ratio, and the first height is less than the second height. The first height and the second height are not described herein again, refer to FIG. 3 described above. Details are not repeated one by one herein.

In conclusion, in the method provided in this embodiment, the first region in the virtual environment is displayed in the first screen having the first aspect ratio, and the second region in the virtual environment is displayed in the second screen having the second aspect ratio. A first ratio between the first aspect ratio of the first screen and the second aspect ratio of the second screen is constrained to be greater than a second ratio between an area of the first region and an area of the second region by increasing a height of the virtual camera, to reduce a difference in areas in the virtual environment corresponding to pictures displayed on screens having different aspect ratios, so that a difference between field of view values of the observation pictures displayed on the screens having different aspect ratios is reduced, thereby balancing human-computer interaction efficiency when displaying the observation pictures of the virtual environment on the screens having different aspect ratios, and ensuring fairness of executing virtual competition in the virtual environment.

Based on the foregoing descriptions, the height of the virtual camera and the areas in the virtual environment corresponding to different observation pictures are described. Next, the observation picture is further described as follows.

In an exemplary implementation, the first observation picture is an observation result of the first region in the virtual environment based on the embodiment shown in FIG. 5. The first region includes n sub-regions, and each of the sub-regions includes at least one pixel point. A quantity of pixel points included in the sub-region or an aspect ratio of the sub-region are not limited in this embodiment, and sizes of different sub-regions are usually the same, but a case in which the sizes of different sub-regions are different is not excluded. The n sub-regions included in the first region do not overlap with each other, and any position point in the first region belongs to a sub-region.

The n sub-regions correspond to n visual weights one-to-one, in other words, each of the sub-region has a corresponding visual weight, and the visual weight is configured for indicating importance of the sub-region in the first observation picture. A part located at a center point of the first observation picture has higher importance compared to a part located at an edge of the first observation picture, and a visual weight corresponding to the part located at the center point of the first observation picture is greater than a visual weight corresponding to the part located at the edge of the first observation picture. Exemplarily, an i^{th} visual weight in the n visual weights is negatively correlated with an i^{th} distance. The i^{th} distance is a distance between an i^{th} sub-region in the n sub-regions and a center point of the first region. n is an integer greater than 1, and i is a positive integer not greater than n.

Exemplarily, a negative correlation between the i^{th} visual weight and the i^{th} distance may be constructed based on at least one of a linear function, a quadratic function, an exponential function, and a logarithmic function. This is not limited in this application. The negative correlation is only configured for constraining the visual weight to decrease as the distance increases.

Further, a visually salient region exists in the first observation picture, and the visually salient region is a region including the center point of the first observation picture. Exemplarily, a visual weight corresponding to a first sub-region in the visually salient region is obtained based on a first function. An independent variable of the first function is a position of the first sub-region in the first observation picture, and a dependent variable of the first function is determined as the visual weight. A second sub-region in other regions outside the visually salient region is obtained based on a second function. Similarly, an independent variable of the second function is a position of the second sub-region in the first observation picture, and a dependent variable of the second function is determined as the visual weight. Exemplarily, a difference between a maximum value of the second function and a minimum value of the first function is greater than a difference threshold.

Exemplarily, a sum of the n visual weights is a first value. The first value may be a preset fixed value, or may be set based on a human-computer interaction operation or information in the virtual environment.

In an example, the first value is the fixed value. In a development process in which an application provides the virtual environment, an initial imaging ratio of the virtual camera displays an initial region in the virtual environment. The initial region includes at least two sub-regions, and the at least two sub-regions correspond to at least two visual weights one-to-one. A calculation manner of a visual weight of a sub-region in the initial region is the same as a calculation manner of a visual weight of the first region described above. The first value is a sum of visual weights of at least two sub-regions of the initial region.

In another example, the first value is set based on a human-computer interaction manner. The application providing the virtual environment provides a setting interface for the first value for a user of the application to set the first value.

In still another example, a terminal executing this embodiment is a control terminal of a first virtual character, and the control terminal has control permission on the first virtual character. In a case in which a virtual activity of the first virtual character in the virtual environment satisfies a constraint threshold, the first value is set to x. In a case in which the virtual activity of the first virtual character in the virtual environment satisfies the constraint threshold, the first value is set to y. The constraint threshold includes that a quantity of times the first virtual character is continuously knocked down exceeds the first value (such as 3 times), or a virtual level of an enemy virtual character exceeds a virtual level of the first virtual character by a second value (such as exceeding the virtual level by 5). x is greater than y. In a case in which the first virtual character is at a significant disadvantage in virtual competition in the virtual environment, the first value is set to a large value, so that a controlling party of the first virtual character obtains visual information having a higher value on the control terminal, thereby balancing virtual competition capabilities of different virtual objects in the virtual environment, and avoiding a problem of passive participation in the virtual competition caused by the controlling party of the first virtual character continuously being at the significant disadvantage.

Further in one embodiment, the second observation picture is an observation result of the second region in the virtual environment. The second region includes m sub-regions, and each of the sub-regions includes at least one pixel point. Similar to the foregoing descriptions, a quantity of pixel points, an aspect ratio, a size, and the like included in the sub-region are not limited. The m sub-regions included in the second region do not overlap with each other, and any position point in the second region belongs to a sub-region.

The m sub-regions are in one-to-one correspondence with m visual weights. Similar to the visual weight corresponding to the sub-region in the first region, a j^{th} visual weight in the m visual weights is negatively correlated with a j^{th} distance. The j^{th} distance is a distance between a j^{th} sub-region in the m sub-regions and a center point of the second region. m is an integer greater than 1, and j is a positive integer not greater than m. A negative correlation between the j^{th} visual weight and the j^{th} distance may be the same as or different from the negative correlation between the visual weight of the sub-region in the first region and the distance described above.

Exemplarily, a sum of the m visual weights is a second value. Similar to the first value, the second value may be a preset fixed value, or may be set based on the human-computer interaction operation or the information in the virtual environment.

In this embodiment, a difference between the first value and the second value does not exceed the difference threshold. The difference threshold is configured for constraining the difference between the first value and the second value, and can ensure that importance of information presented by the first observation picture to the user is similar to or same as importance of information presented by the second observation picture to the user. The difference in the areas in the virtual environment of the observation pictures displayed on the screens having different aspect ratios is reduced, so that visual importance of information presented by the observation pictures on the screens having different aspect ratios is balanced from a dimension of visual importance.

FIG. 6 is a flowchart of a processing method for an observation picture according to an exemplary embodiment of this application. The method may be performed by a terminal. The method includes:

Operation 502: Determine, based on a weight association relationship, s visual weights in one-to-one correspondence with s sub-regions in a virtual environment.

For example, a candidate region is constructed based on the s sub-regions, and the candidate region includes the s sub-regions. An aspect ratio of the candidate region is a first aspect ratio. Each of the s visual weights is a visual weight of a corresponding current sub-region relative to a center point of the candidate region, and s is an integer greater than or equal to n.

Exemplarily, a manner of determining the visual weight is similar to that of the first region and the second region described above. A weight association relationship is configured for indicating a negative correlation between a visual weight and an offset distance. The offset distance is a distance between the current sub-region corresponding to the visual weight and the center point of the candidate region.

Operation 502 to operation 506 in this embodiment are configured for determining a first height of a virtual camera, but do not limit a position in which a candidate region, constructed in a process of determining the first height, is located in the virtual environment. The candidate region may be located at any position in the virtual environment, or may be in another environment having the same metric unit as the virtual environment, and is only configured for determining a target region. Then, the virtual camera is determined to be located at the first height based on a size of the target region. In other words, a position of the candidate region or a virtual item in the candidate region are not limited.

Operation 504: Screen out the target region from the candidate region.

Because the s visual weights corresponding to the s sub-regions one-to-one are visual weights relative to the center point of the candidate region. A center point of the target region obtained through screening is the same as the center point of the candidate region. Because the center point of the target region is the same as the center point of the candidate region, a smaller size of the sub-region indicates a smaller step size when screening out the target region.

Exemplarily, an aspect ratio of the target region is the first aspect ratio, and a sum of visual weights of sub-regions in the target region is a first value.

Operation 506: Determine, based on the size of the target region, that the virtual camera is located at the first height.

Exemplarily, the size of the target region is positively correlated with a height of the virtual camera. As shown in sub-figure (b) of FIG. 3, as the size of the target region increases, the height of the virtual camera increases. Exemplarily, a one-to-one association relationship exists between the size of the target region and the first height, and the association relationship is obtained by the terminal.

In this embodiment, only a manner of determining that the virtual camera is located at the first height in operation 512 is described. However, it is not excluded that in some other embodiments, a manner of determining that the virtual camera is located at a second height in operation 522 is also determined in a similar manner. For example, s′ visual weights corresponding to s′ sub-regions one-to-one in the virtual environment are determined based on the weight association relationship. An aspect ratio of a candidate region constructed based on the s′ sub-regions is a second aspect ratio, and each of the s′ visual weights is a visual weight of a corresponding current sub-region relative to a center point of the candidate region. s′ is an integer greater than or equal to m. A target region is screened out from the candidate region. A center point of the target region is the same as the center point of the candidate region, an aspect ratio of the target region is the second aspect ratio, and a sum of visual weights of sub-regions in the target region is a second value. It is determined that the virtual camera is located at the second height based on a size of the target region.

Operation 512: Display a first observation picture in a first screen having the first aspect ratio, and obtain the first observation picture through observation by using the virtual camera located at the first height in the virtual environment. The display incudes generating a first observation picture by using a first virtual camera located at a first height in the virtual environment for a first screen of a first terminal having a first aspect ratio, the first observation picture being an observation result of a first region in the virtual environment, and an area of the first region in the virtual environment being a first area.

As described above, the virtual environment is observed by using the virtual camera deployed in the virtual environment. An example in which the virtual camera observes the virtual environment at a top view is used for description in this embodiment. Exemplarily, when the virtual camera observes the virtual environment at the top view, an aspect ratio of a first region displayed in a first display picture is the same as the first aspect ratio of the first screen.

Operation 522: Display a second observation picture in a second screen having the second aspect ratio, and obtain the second observation picture through observation by using the virtual camera located at a second height in the virtual environment. The display includes generating a second observation picture by using a second virtual camera located at a first height in the virtual environment for a second screen of a second terminal having a second aspect ratio, the second observation picture being an observation result of a second region in the virtual environment, and an area of the second region in the virtual environment being a second area.

Similarly, exemplarily, when the virtual camera observes the virtual environment at the top view, an aspect ratio of a second region displayed in a second display picture is the same as the second aspect ratio of the second screen.

The first aspect ratio is greater than the second aspect ratio, and the first height is less than the second height.

For other descriptions of operation 512 and operation 522, refer to the foregoing embodiment corresponding to FIG. 5, and the related descriptions that the first region includes the n sub-regions and the second region includes the m sub-regions. Details are not repeated here one by one.

In conclusion, in the method provided in this embodiment, the target region in which the sum of visual weights is the first value is screened out from the candidate region based on visual weights of sub-regions included in the candidate region relative to the center point of the candidate region, to ensure that the displayed first observation picture has the same visual weight as the displayed second observation picture. The visual weight of the sub-region is determined, so that the observation pictures displayed in the first screen and the second screen having different aspect ratios are constrained from a dimension of visual importance, thereby balancing human-computer interaction efficiency when displaying the observation pictures of the virtual environment on the screens having different aspect ratios, and ensuring fairness of executing virtual competition in the virtual environment.

Next, the weight association relationship is further described. The weight association relationship includes a first sub-relationship and a second sub-relationship.

In an exemplary implementation, operation 502 may be implemented as the following two sub-operations:
Determine, based on the first sub-relationship, s1 visual weights in one-to-one correspondence with s1 sub-regions.

In this embodiment, a terminal displaying the first observation picture has control permission or spectator permission of a first virtual character in the virtual environment. The first sub-relationship is configured for indicating a negative correlation between a visual weight and the offset distance when the offset distance exceeds a distance threshold.

The distance threshold is a maximum observation distance of the first virtual character in the virtual environment. A multiplayer online battle arena (MOBA) game is used as an example, an observation distance of the first virtual character to surroundings is limited, for example, the maximum observation distance is 1000 meters. When the terminal displays a virtual environment exceeding the maximum observation distance, a mask color exists, for example, a black mask, to shield a virtual environment outside the maximum observation distance, and the black mask is also referred to as existence of virtual fog.

Correspondingly, the first sub-relationship is configured for indicating a visual weight of a virtual position outside the maximum observation distance. In some examples, the first sub-relationship indicates a relationship between the visual weight and the offset distance by using a first function, and the first function is different from a second function corresponding to the second sub-relationship.
Determine, based on the second sub-relationship, s2 visual weights in one-to-one correspondence with s2 sub-regions.

The second sub-relationship in the weight association relationship is configured for indicating a negative correlation between a visual weight and the offset distance when the offset distance does not exceed the distance threshold. The distance threshold is the maximum observation distance of the first virtual character in the virtual environment.

In this embodiment, s is a sum of s1 and s2, and s1 and s2 are both positive integers.

Different association relationships are set for different regions inside and outside the maximum observation distance of the first virtual character through the first sub-relationship and the second sub-relationship, so that a situation in which the mask color exists outside the maximum observation distance of the first virtual character to shield the virtual environment outside the maximum observation distance is fully considered, and is a special scheme designed for a visible range of the first virtual character.

In an exemplary implementation, the s sub-regions include a first sub-region, a second sub-region, and a third sub-region. A first offset distance and a second offset distance both in one-to-one correspondence with the first sub-region and the second sub-region do not exceed the distance threshold, and a third offset distance corresponding to the third sub-region exceeds the distance threshold.

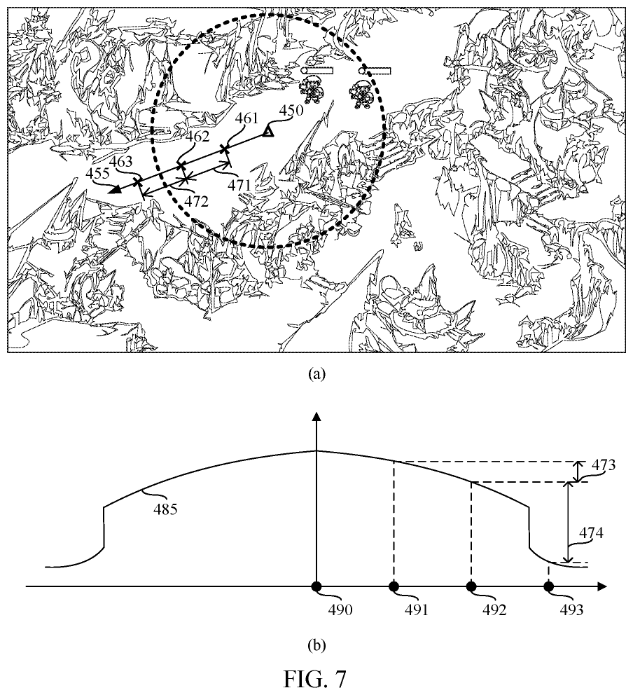

FIG. 7 is a schematic diagram of an observation picture according to an exemplary embodiment of this application. As shown in sub-figure (a), a character position 450 is a position of a first virtual character in a virtual environment. To avoid picture occlusion, the first virtual character is not displayed in sub-figure (a), and the character position 450 is only indicated by using a triangle symbol.

A center position in which a first sub-region is located is a first position 461, a center position in which a second sub-region is located is a second position 462, and a center position in which a third sub-region is located is a third position 463. A first ray 455 is a ray starting from the character position 450, and passing through the first position 461, the second position 462, and the third position 463. FIG. 7 only shows a case in which the foregoing three positions are on the same ray, but does not exclude a case in which the foregoing three positions are not on one ray in another example.

As described above, a first offset distance corresponding to the first sub-region is a straight-line distance from the first position 461 to the character position 450, and a manner of determining a second offset distance and a third offset distance is similar to that of determining the first offset distance. Details are not repeated one by one. A difference between the first offset distance and the second offset distance is a first difference 471, a difference between the second offset distance and the third offset distance is a second difference 472, and the first difference and the second difference are equal and are both positive numbers.

As shown in sub-figure (b), a horizontal axis of a two-dimensional coordinate system corresponds to a direction of the first ray 455 in the virtual environment. A vertical axis of the two-dimensional coordinate system is configured for indicating a visual weight. The character position 450 in sub-figure (a) is an origin 490 of the two-dimensional coordinate system in sub-figure (b). The first position 461 in the sub-figure (a) corresponds to a first horizontal coordinate 491 on the horizontal axis in the sub-figure (b). Similarly, the second position 462 and the third position 463 in sub-figure (a) respectively correspond to a second horizontal coordinate 492 and a third horizontal coordinate 493 on the horizontal axis in sub-figure (b).

As shown in a sub-figure (b), a function 485 in the two-dimensional coordinate system is configured for indicating a weight association relationship, and is configured for indicating a visual weight of a coordinate at a distance from the origin 490. In an example, the visual weight corresponding to the origin 490 is 1. Visual weights at other positions are less than 1.

A first visual weight corresponding to the first sub-region is a value of a vertical coordinate of the function 485 in the first horizontal coordinate 491. As shown in sub-figure (b), a difference between the first visual weight corresponding to the first sub-region and a second visual weight corresponding to the second sub-region is a third difference 473, a difference between the second visual weight corresponding to the second sub-region and a third visual weight corresponding to the third sub-region is a fourth difference 474, and the third difference 473 is less than the fourth difference 474.

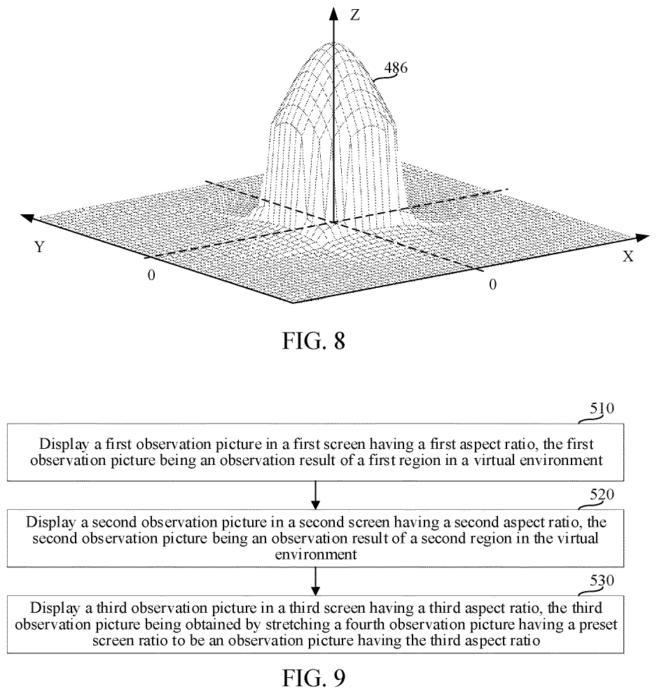

FIG. 8 is a schematic diagram of a visual weight according to an exemplary embodiment of this application. An XOY plane corresponds to a horizontal plane of a virtual environment, and a position of an original point on the XOY plane is a position of a first virtual character in the virtual environment. In FIG. 8, a weight association relationship is implemented as a three-dimensional function 486. A visual weight of a position in the virtual environment is a Z-axis coordinate of the three-dimensional function at the position.

A first aspect ratio and a second aspect ratio are further described as follows.

Based on the embodiment shown in FIG. 4, both the first aspect ratio and the second aspect ratio described in FIG. 4 are not within a preset ratio range. The preset ratio range is determined based on a preset screen ratio and a tolerance parameter.

Exemplarily, the preset screen ratio is an initial imaging ratio of a virtual camera in a development process in which an application provides the virtual environment. Exemplarily, the initial imaging ratio is an attribute parameter of the virtual camera at a development stage of the application, for example, 16:9. The development stage of the application is usually provided with one initial imaging ratio, but a situation in which a plurality of imaging ratios are provided is not excluded. For example, an initial imaging ratio of a smart phone is 16:7, and an initial imaging ratio of a personal computer (PC) is 16:9.

Exemplarily, the tolerance parameter is a preset empirical value, for example, an initial value set by a developer of the application. The tolerance parameter is a positive number less than 1. Further, the tolerance parameter is less than 20%. The tolerance parameter is configured for indicating a constraint threshold for a stretching degree of an observation picture having the preset screen ratio.

In a case in which a ratio of the preset screen ratio is a: b (a greatest common divisor between a and b is 1), and a value of the tolerance parameter is c. In an example, the preset ratio range is a*(1+c):b to a:b*(1+c). In another example, the preset ratio range is (a:b)(1+c) to (a:b)(1−c).

Further in one embodiment, FIG. 9 is a flowchart of a processing method for an observation picture according to an exemplary embodiment of this application. The method may be performed by a terminal. To be specific, based on the embodiment shown in FIG. 4, operation 530 is further included.

Operation 530: Display a third observation picture in a third screen having a third aspect ratio, the third observation picture being obtained by stretching a fourth observation picture having the preset screen ratio to be an observation picture having the third aspect ratio. In some embodiments, the display includes generating a third observation picture for a third screen of a third terminal having a third aspect ratio by stretching a fourth observation picture having an aspect ratio having the preset screen ratio to be an observation picture having the third aspect ratio.

The third observation picture has the same aspect ratio as the third screen, and matches the third screen. The third observation picture is an observation result of a third region in a virtual environment.

In this embodiment, the third observation picture is obtained by stretching the fourth observation picture having the preset screen ratio to be the observation picture having the third aspect ratio. Correspondingly, the third region in the virtual environment has the same aspect ratio as the fourth observation picture, that is, the preset screen ratio.

Exemplarily, the fourth observation picture is an observation picture of the virtual environment captured by a virtual camera based on an initial imaging ratio. The third aspect ratio belongs to a preset ratio range. In a case in which the third aspect ratio belongs to the preset ratio range, a difference between the third aspect ratio and the preset screen ratio is small, and stretching performed on the fourth observation picture does not exceed a constraint threshold of a stretching degree for an observation picture having the preset screen ratio. The fourth observation picture is directly stretched to obtain the third observation picture, which considers both a display effect and calculation complexity of the observation picture, so that adjustment of an aspect ratio and a height of an imaging picture of the virtual camera is avoided, thereby saving consumption of calculation resources when ensuring that the stretching degree of the observation picture is limited.

Operation 530 may be performed before, after, or simultaneously with any one of operation 510 and operation 520. The execution sequence is not limited in this application.

A first screen, a second screen, and a third screen may be different screens of the same terminal, or may be different screens of different terminals. A quantity of terminals and a quantity of screens on one terminal are not limited in this application.

In conclusion, in the method provided in this embodiment, the third observation picture is obtained in a stretching manner for the third screen within the preset ratio range. The stretching performed on the fourth observation picture does not exceed the constraint limit of the stretching degree of the observation picture having the preset screen ratio. The fourth observation picture is directly stretched to obtain the third observation picture, which takes into account both the display effect and the calculation complexity of the observation picture, so that the adjustment of the aspect ratio and the height of the imaging picture of the virtual camera is avoided, thereby saving the consumption of the calculation resources when ensuring that the stretching degree of the observation picture is limited to have a small impact on a corresponding area in the virtual environment.

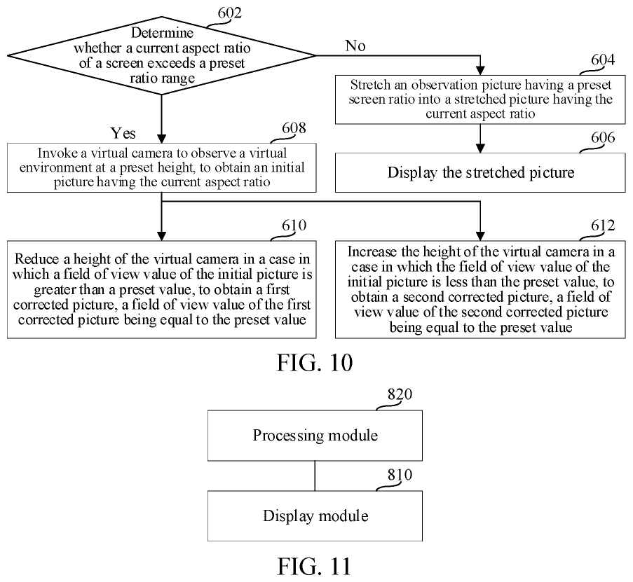

FIG. 10 is a flowchart of a processing method for an observation picture according to an exemplary embodiment of this application. The method may be performed by a terminal. The method includes:

operation 602: Determine whether a current aspect ratio of a screen exceeds a preset ratio range.

Exemplarily, the preset ratio range is determined based on a preset screen ratio and a tolerance parameter. The preset screen ratio is an initial imaging ratio of a virtual camera in a development process in which an application provides a virtual environment. The initial imaging ratio is an attribute parameter of the virtual camera at a development stage of the application, for example, 16:9. The tolerance parameter is a preset empirical value, and the tolerance parameter is a positive number less than 1. Further, the tolerance parameter is less than 20%. The tolerance parameter is configured for indicating a constraint threshold for a stretching degree of an observation picture having the preset screen ratio. In an example, the initial imaging ratio is 16:9, and the tolerance parameter is 0.1. The preset ratio range is 16*1.1:9 to 16:9*1.1.

Operation 604: Stretch the observation picture having the preset screen ratio into a stretched picture having the current aspect ratio.

In a case in which it is determined that the aspect ratio of the screen does not exceed the preset ratio range in operation 602, operation 604 is performed.

As described above, the observation picture having the preset screen ratio (that is, the observation picture whose aspect ratio is 16:9) is stretched into the stretched picture having the current aspect ratio. In a case in which the current aspect ratio of the screen belongs to the preset ratio range, a difference between the current aspect ratio of the screen and the preset screen ratio is small. Stretching performed on the observation picture having the preset screen ratio does not exceed the constraint threshold of the stretching degree of the observation picture. The stretching is directly performed to obtain the stretched picture, which considers both a display effect and calculation complexity of the observation picture in the virtual environment, so that adjustment of an aspect ratio and a height of an imaging picture of the virtual camera is avoided, thereby saving consumption of computing resources when ensuring that the stretching degree of the observation picture is limited.

Operation 606: Display the stretched picture.

The stretched picture has the same aspect ratio as the screen, and matches the screen.

Operation 608: Invoke the virtual camera to observe the virtual environment at a preset height, to obtain an initial picture having the current aspect ratio.

In a case in which it is determined that the current aspect ratio of the screen exceeds the preset ratio range in operation 602, operation 608 is performed. The preset height is a height of the virtual camera in the virtual environment when an imaging picture has the preset screen ratio. The preset height is set by an application providing the virtual environment at the development stage. In a case in which the height of the virtual camera remains unchanged, that is, at the preset height, an aspect ratio of an imaging plane of the virtual camera is adjusted, to obtain the initial picture having the current aspect ratio. The initial picture having the current aspect ratio matches the screen having the current aspect ratio.

Operation 610: Reduce the height of the virtual camera when a field of view value of the initial picture is greater than a preset value, to obtain a first corrected picture, a field of view value of the first corrected picture being equal to the preset value.

The field of view value is a sum of visual weights of sub-regions in the initial picture. For descriptions of the visual weights, refer to related descriptions of the n sub-regions and the m sub-regions above. Details are not repeated one by one herein.

In this operation, when the field of view value of the initial picture is greater than the preset value, the height of the virtual camera is reduced. The first corrected picture obtained after reducing the height of the virtual camera includes fewer sub-regions than the initial picture, and correspondingly, the field of view value of the first corrected picture is less than the field of view value of the initial picture.

The first corrected picture is a subset of the initial picture, and the field of view value of the first corrected picture is equal to the preset value. For description of the preset value, refer to the first value and the second value described above. Details are not repeated one by one herein.

Operation 612: Increase the height of the virtual camera when the field of view value of the initial picture is less than the preset value, to obtain a second corrected picture, a field of view value of the second corrected picture being equal to the preset value.

In this operation, when the field of view value of the initial picture is less than the preset value, the height of the virtual camera is increased. The second corrected picture obtained after increasing the height of the virtual camera includes more sub-regions than the initial picture, and correspondingly, the field of view value of the second corrected picture is greater than the field of view value of the initial picture.

The initial picture is a subset of the second corrected picture, and the field of view value of the second corrected picture is equal to the preset value. For description of the preset value, refer to the first value and the second value described above. Details are not repeated one by one herein.

A person of ordinary skill in the art may understand that the foregoing embodiments may be independently implemented, or the foregoing embodiments may be freely combined to obtain a new embodiment, to implement the processing method for the observation picture of this application.

FIG. 11 is a block diagram of a structure of a processing apparatus for an observation picture according to an exemplary embodiment of this application. The apparatus includes: a display module 810 is configured to perform operation 510 in the embodiment shown in FIG. 4. An area of a first region in a virtual environment is a first area. The display module 810 is further configured to perform operation 520 in the embodiment shown in FIG. 4. An area of a second region in the virtual environment is a second area. A ratio between a first aspect ratio and a second aspect ratio is a first ratio, a ratio between the first area and the second area is a second ratio, and the first ratio is greater than the second ratio. A first screen and A second screen are different screens of THE same terminal, or the first screen and the second screen are different screens of different terminals.

In an exemplary implementation of this embodiment, the display module 810 is further configured to perform operation 512 and operation 522 in the embodiment shown in FIG. 5. The first aspect ratio is greater than the second aspect ratio, and a first height is less than a second height.

In an exemplary implementation of this embodiment, the first region includes n sub-regions, and the n sub-regions correspond to n visual weights one-to-one. A sum of the n visual weights is a first value.

An i^{th} visual weight in the n visual weights is negatively correlated with an i^{th} distance, and the i^{th} distance is a distance between an i^{th} sub-region in the n sub-regions and a center point of the first region. n is an integer greater than 1, and i is a positive integer not greater than n.

In an exemplary implementation of this embodiment, the second region includes m sub-regions, and the m sub-regions are in one-to-one correspondence with m visual weights. A sum of the m visual weights is a second value, and a difference between the first value and the second value does not exceed a difference threshold.

A j^{th} visual weight in the m visual weights is negatively correlated with a j^{th} distance, and the j^{th} distance is a distance between a j^{th} sub-region in the m sub-regions and a center point of the second region. m is an integer greater than 1, and j is a positive integer not greater than m.

In an exemplary implementation of this embodiment, the apparatus further includes a processing module 820. The processing module 820 is configured to: perform operation 502 in the embodiment shown in FIG. 6, each of s visual weights being a visual weight corresponding a current sub-region relative to a center point of a candidate region, and s being an integer greater than or equal to n; perform operation 504 in the embodiment shown in FIG. 6, the candidate region including the s sub-regions, an aspect ratio of the candidate region is the first aspect ratio, a center point of a target region being the same as the center point of the candidate region, an aspect ratio of the target region being the first aspect ratio, and a sum of visual weights of sub-regions in the target region being the first value; and perform operation 506 in the embodiment shown in FIG. 6, a weight association relationship being configured for indicating a negative correlation between a visual weight and an offset distance, and the offset distance being a distance between the current sub-region corresponding to the visual weight and the center point of the candidate region.

In an exemplary implementation of this embodiment, a terminal displaying the first observation picture has control permission or spectator permission on a first virtual character in the virtual environment. The weight association relationship includes a first sub-relationship and a second sub-relationship. The processing module 820 is further configured to:
determine, based on the first sub-relationship, s1 visual weights in one-to-one correspondence with s1 sub-regions; and
determine, based on the second sub-relationship, s2 visual weights in one-to-one correspondence with s2 sub-regions.

The first sub-relationship in the weight association relationship is configured for indicating a negative correlation between a visual weight and the offset distance when the offset distance exceeds a distance threshold. The second sub-relationship in the weight association relationship is configured for indicating a negative correlation between a visual weight and the offset distance when the offset distance does not exceed the distance threshold. The distance threshold is a maximum observation distance of the first virtual character in the virtual environment, s is a sum of s1 and s2, and s1 and s2 are both positive integers.

In an exemplary implementation of this embodiment, the s sub-regions include a first sub-region, a second sub-region, and a third sub-region. A first offset distance and a second offset distance in one-to-one correspondence with the first sub-region and the second sub-region do not exceed the distance threshold, and a third offset distance corresponding to the third sub-region exceeds the distance threshold.

A difference between the first offset distance and the second offset distance is a first difference value, a difference between the second offset distance and the third offset distance is a second difference value, and the first difference value is equal to the second difference value. A difference between a first visual weight corresponding to the first sub-region and a second visual weight corresponding to the second sub-region is a third difference value, a difference between the second visual weight corresponding to the second sub-region and a third visual weight corresponding to the third sub-region is a fourth difference value, and the third difference value is less than the fourth difference value.

In an exemplary implementation of this embodiment, neither the first aspect ratio nor the second aspect ratio belongs to a preset ratio range. The preset ratio range is determined based on a preset screen ratio and a tolerance parameter. The preset screen ratio is an initial imaging ratio of a virtual camera in a development process in which an application provides the virtual environment.

In an exemplary implementation of this embodiment, the display module 810 is further configured to perform operation 530 in the embodiment shown in FIG. 9. A fourth observation picture is an observation picture of the virtual environment captured by the virtual camera based on the initial imaging ratio. A third aspect ratio belongs to the preset ratio range.

In an exemplary implementation of this embodiment, the virtual environment is provided by at least one of a multiplayer online battle arena game and a real-time strategy game, and/or the first observation picture and the second observation picture are pictures obtained by observing the virtual environment at a top view.

In the apparatus provided in the above embodiments, only division of the above functional modules is used as an example for description when functions of the apparatus are implemented. In an actual application, the foregoing functions may be allocated to different functional modules for completion based on an actual requirement, in other words, an internal structure of the device is divided into different functional modules, to complete all or some of the functions described above.

Specific manners in which the respective modules execute operations have been described for the apparatus in the foregoing embodiment in detail in the embodiments related to the method. Technical effects obtained by executing the operations by the respective modules are the same as those in the embodiments related to the method. Details are not described herein again.

An embodiment of this application further provides a computer device. The computer device includes a processor and a memory, and the memory stores a computer program. The processor is configured to execute the computer program in the memory to implement the processing method for the observation picture provided in the foregoing method embodiments.

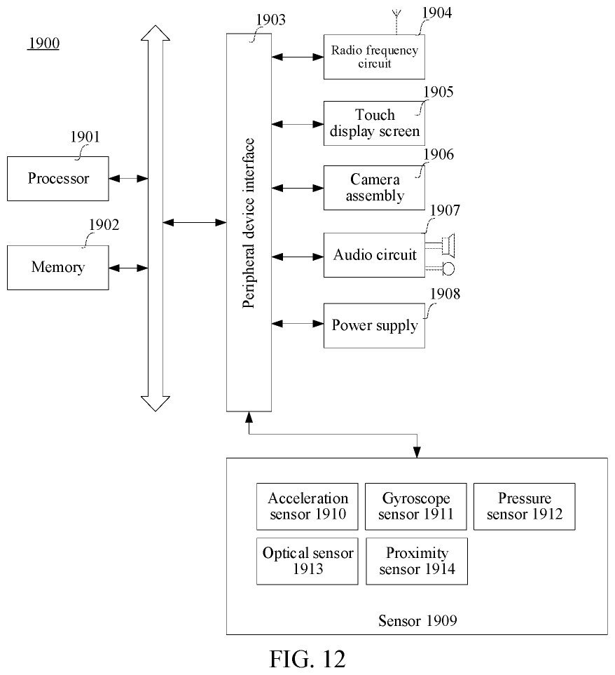

FIG. 12 is a block diagram of a structure of a terminal according to an exemplary embodiment of this application. A terminal 1900 may be a smart phone, a tablet computer, a moving picture experts group audio layer III (MP3) player, a moving picture experts group audio layer IV (MP4) player, a laptop computer, or a desktop computer. The terminal 1900 may alternatively be referred to as a user equipment, a portable terminal, a laptop terminal, a desktop terminal, or another name.

The terminal 1900 includes a processor 1901 and a memory 1902. The processor 1901 may include one or more processing cores, such as a 4-core processor, an 8-core processor, or the like. The processor 1901 may be implemented by using at least one hardware form of digital signal processing (DSP), a field programmable gate array (FPGA), or a programmable logic array (PLC). The processor 1901 may further include a main processor and a co-processor. The main processor is a processor configured to process data in a wakeup state, and also referred to as a central processing unit (CPU). The co-processor is a low-power processor configured to process data in a standby state. In some embodiments, the processor 1901 may be integrated with a graphics processing unit (GPU). The GPU is configured to be responsible for rendering and drawing content that needs to be displayed on a display screen. In some embodiments, the processor 1901 may further include an artificial intelligence (AI) processor. The AI processor is configured to process a calculation operation related to machine learning.

The memory 1902 may include one or more computer-readable storage media, and the computer-readable storage media may be non-transitory. The memory 1902 may further include a high-speed random access memory, and a non-volatile memory such as one or more magnetic disk storage devices and flash storage devices. In some embodiments, the non-transitory computer-readable storage medium in the memory 1902 is configured to store at least one instruction. The at least one instruction is executed by the processor 1901 to implement the processing method for the observation picture provided in the method embodiments of this application.

In some embodiments, the terminal 1900 may further includes a peripheral device interface 1903 and at least one peripheral device. The processor 1901, the memory 1902, and the peripheral device interface 1903 may be connected to each other through a bus or a signal line. The peripheral devices may be connected to the peripheral device interface 1903 through a bus, a signal line, or a circuit board. Specifically, the peripheral device includes at least one of a radio frequency circuit 1904, a touch display screen 1905, a camera assembly 1906, an audio circuit 1907, and a power supply 1908.

The peripheral device interface 1903 may be configured to connect at least one input/output (I/O) related peripheral device to the processor 1901 and the memory 1902. In some embodiments, the processor 1901, the memory 1902, and the peripheral interface 1903 are integrated on the same chip or circuit board. In some other embodiments, any one or two of the processors 1901, the memory 1902, and the peripheral device interface 1903 may be implemented on an independent chip or circuit board. This is not limited in this embodiment. The radio frequency circuit 1904 is configured to receive and transmit radio frequency (RF) signals, also referred to as an electromagnetic signal. The radio frequency circuit 1904 communicates with a communication network and another communication device by using the electromagnetic signal. The radio frequency circuit 1904 may further include a circuit related to near field communication (NFC). The touch display screen 1905 is configured to display a user interface (UI). The UI may include a graph, a text, an icon, a video, or any combination thereof. The camera assembly 1906 is configured to capture an image or a video. In one embodiment, the camera assembly 1906 includes a front camera and a rear camera. The audio circuit 1907 may include a microphone and a speaker. The microphone is configured to collect sound waves of a user and an environment, and convert the sound waves into electrical signals inputted to the processor 1901 for processing, or input the electrical signals to the radio frequency circuit 1904 to implement voice communication. The power supply 1908 is configured to supply power to components in the terminal 1900. The power supply 1908 may be alternating current, direct current, a disposable battery, or a rechargeable battery.

In some embodiments, the terminal 1900 further includes one or more sensors 1909. The one or more sensors 1909 include, but are not limited to, an acceleration sensor 1910, a gyroscope sensor 1911, a pressure sensor 1912, an optical sensor 1913, and a proximity sensor 1914. The acceleration sensor 1910 can detect magnitudes of accelerations on three coordinate axes of a coordinate system established by the terminal 1900. The pressure sensor 1912 may be disposed on a side frame of the terminal 1900 and/or a lower layer of the touch display screen 1905. A grip signal of the user on the terminal 1900 is detected, and/or an operable control on a UI interface is controlled based on a pressure operation of the user on the touch display screen 1905. The optical sensor 1913 is configured to collect an ambient light intensity. The proximity sensor 1914 is also referred to as a distance sensor, and is usually disposed on a front panel of the terminal 1900. The proximity sensor 1914 is configured to collect a distance between the user and a front surface of the terminal 1900.

A person skilled in the art may understand that the structure shown in FIG. 12 does not constitute a limitation to the terminal 1900, and the terminal 1200 may include more components or fewer components than those shown in the figure, or some components may be combined, or a different component deployment may be used.

In an exemplary embodiment, a chip is provided. The chip includes a programmable logic circuit and/or a program instruction. When the chip runs on a computer device, the chip is configured to implement the processing method for the observation picture according to the foregoing aspect.

In an exemplary embodiment, a computer program product is further provided. The computer program product includes computer instructions, and the computer instructions are stored in a computer-readable storage medium. A processor of the computer device reads the computer instructions from the computer-readable storage medium, and executes the computer instructions to implement the processing method for the observation picture provided in the foregoing method embodiments.

In an exemplary embodiment, a computer-readable storage medium is further provided. The computer-readable storage medium has a computer program stored therein, and the computer program is loaded and executed by the processor to implement the processing method for the observation picture provided in the foregoing method embodiments.

A person of ordinary skill in the art may understand that all or some of the operations of the foregoing embodiments may be implemented by using hardware, or may be implemented by instructing related hardware by a program. The program may be stored in a computer-readable storage medium. The storage medium may be a read-only memory, a magnetic disk, an optical disc, or the like.

A person skilled in the art is to be aware that in the foregoing one or more examples, functions described in the embodiments of this application may be implemented by using hardware, software, firmware, or any combination thereof. When implemented by using the software, the functions may be stored in the computer-readable medium or transmitted as one or more instructions or code in the computer-readable medium. The computer-readable medium includes a computer storage medium and a communication medium. The communication medium includes any medium that enables the computer program to be transmitted from one place to another. The storage medium may be any available medium that can be accessed by a general-purpose or special-purpose computer.

What is claimed is:

1. A method for generating an observation picture of a virtual environment performed by a computer device, the method comprising:
generating a first observation picture by using a first virtual camera located at a first height in the virtual environment for a first screen of a first terminal having a first aspect ratio, the first observation picture being an observation result of a first region in the virtual environment, and an area of the first region in the virtual environment being a first area; and
generating a second observation picture by using a second virtual camera located at a first height in the virtual environment for a second screen of a second terminal having a second aspect ratio, the second observation picture being an observation result of a second region in the virtual environment, and an area of the second region in the virtual environment being a second area, wherein:
a ratio between the first aspect ratio and the second aspect ratio being a first ratio, a ratio between the first area and the second area being a second ratio, and the first ratio being greater than the second ratio; and the first aspect ratio being greater than the second aspect ratio, and the first height being less than the second height.

2. The method according to claim 1, wherein the first region comprises n sub-regions, and the n sub-regions are in one-to-one correspondence with n visual weights; and a sum of the n visual weights is a first value; and
an i^{th} visual weight in the n visual weights is negatively correlated with an i^{th} distance, and the i^{th} distance is a distance between an i^{th} sub-region in the n sub-regions and a center point of the first region; and n is an integer greater than 1, and i is a positive integer not greater than n.

3. The method according to claim 2, wherein the second region comprises m sub-regions, and the m sub-regions are in one-to-one correspondence with m visual weights; a sum of the m visual weights is a second value, and a difference between the first value and the second value does not exceed a difference threshold; and
a j^{th} visual weight in the m visual weights is negatively correlated with a j^{th} distance, and the j^{th} distance is a distance between a j^{th} sub-region in the m sub-regions and a center point of the second region; and m is an integer greater than 1, and j is a positive integer not greater than m.

4. The method according to claim 2, wherein the method further comprises:
determining, based on a weight association relationship, s visual weights in one-to-one correspondence with s sub-regions in the virtual environment, each of the s visual weights being a visual weight of a corresponding current sub-region relative to a center point of a candidate region, and s being an integer greater than or equal to n;
screening out a target region from the candidate region, the candidate region comprising the s sub-regions, an aspect ratio of the candidate region being the first aspect ratio, a center point of the target region being the same as the center point of the candidate region, an aspect ratio of the target region being the first aspect ratio, and a sum of visual weights of sub-regions in the target region being the first value; and
determining, based on a size of the target region, that the virtual camera is located at the first height,
the weight association relationship being configured for indicating a negative correlation between a visual weight and an offset distance, and the offset distance being a distance between a current sub-region corresponding to the visual weight and the center point of the candidate region.

5. The method according to claim 4, wherein a terminal displaying the first observation picture has a control permission or a spectator permission for a first virtual character in the virtual environment, and the weight association relationship comprises a first sub-relationship and a second sub-relationship; and
the determining, based on a weight association relationship, s visual weights in one-to-one correspondence with s sub-regions in the virtual environment comprises:
determining, based on the first sub-relationship, s1 visual weights in one-to-one correspondence with s1 sub-regions; and
determining, based on the second sub-relationship, s2 visual weights in one-to-one correspondence with s2 sub-regions,
the first sub-relationship being configured for indicating a negative correlation between a visual weight and the offset distance when the offset distance exceeds a distance threshold; the second sub-relationship being configured for indicating a negative correlation between the visual weight and the offset distance when the offset distance does not exceed the distance threshold; and the distance threshold being a maximum observation distance of the first virtual character in the virtual environment, s being a sum of s1 and s2, and s1 and s2 being both positive integers.

6. The method according to claim 5, wherein the s sub-regions comprise a first sub-region, a second sub-region, and a third sub-region; both a first offset distance and a second offset distance in one-to-one correspondence with the first sub-region and the second sub-region do not exceed the distance threshold, and a third offset distance corresponding to the third sub-region exceeds the distance threshold; and
a difference between the first offset distance and the second offset distance is a first difference value, a difference between the second offset distance and the third offset distance is a second difference value, and the first difference value is equal to the second difference value; and a difference between a first visual weight corresponding to the first sub-region and a second visual weight corresponding to the second sub-region is a third difference value, a difference between the second visual weight corresponding to the second sub-region and a third visual weight corresponding to the third sub-region is a fourth difference value, and the third difference value is less than the fourth difference value.

7. The method according to claim 1, wherein both the first aspect ratio and the second aspect ratio are not within a preset ratio range, the preset ratio range is determined based on a preset screen ratio and a tolerance parameter; and the preset screen ratio is an initial imaging ratio of the virtual camera in a development process in which an application provides the virtual environment.

8. The method according to claim 7, wherein the method further comprises:
generating a third observation picture for a third screen of a third terminal having a third aspect ratio by stretching a fourth observation picture having an aspect ratio having the preset screen ratio to be an observation picture having the third aspect ratio,
the fourth observation picture being an observation picture of the virtual environment captured by the virtual camera based on the initial imaging ratio; and the third aspect ratio being within the preset ratio range.

9. The method according to claim 1, wherein
the virtual environment is provided by at least one of a multiplayer online battle arena (MOBA) game and a real-time strategy (RTS) game; and/or, the first observation picture and the second observation picture are pictures obtained by observing the virtual environment at a top view.

10. A computer device, comprising a processor and a memory, the memory having at least one program stored therein; and the processor being configured to execute the at least one program in the memory, to implement a method for generating an observation picture of a virtual environment:
generating a first observation picture by using a first virtual camera located at a first height in the virtual environment for a first screen of a first terminal having a first aspect ratio, the first observation picture being an observation result of a first region in the virtual environment, and an area of the first region in the virtual environment being a first area; and
generating a second observation picture by using a second virtual camera located at a first height in the virtual environment for a second screen of a second terminal having a second aspect ratio, the second observation picture being an observation result of a second region in the virtual environment, and an area of the second region in the virtual environment being a second area, wherein:
a ratio between the first aspect ratio and the second aspect ratio being a first ratio, a ratio between the first area and the second area being a second ratio, and the first ratio being greater than the second ratio; and the first aspect ratio being greater than the second aspect ratio, and the first height being less than the second height.

11. The computer device according to claim 10, wherein the first region comprises n sub-regions, and the n sub-regions are in one-to-one correspondence with n visual weights; and a sum of the n visual weights is a first value; and
an i^{th} visual weight in the n visual weights is negatively correlated with an i^{th} distance, and the i^{th} distance is a distance between an i^{th} sub-region in the n sub-regions and a center point of the first region; and n is an integer greater than 1, and i is a positive integer not greater than n.

12. The computer device according to claim 11, wherein the second region comprises m sub-regions, and the m sub-regions are in one-to-one correspondence with m visual weights; a sum of the m visual weights is a second value, and a difference between the first value and the second value does not exceed a difference threshold; and
a j^{th} visual weight in the m visual weights is negatively correlated with a j^{th} distance, and the j^{th} distance is a distance between a j^{th} sub-region in the m sub-regions and a center point of the second region; and m is an integer greater than 1, and j is a positive integer not greater than m.

13. The computer device according to claim 12, wherein the method further comprises:
determining, based on a weight association relationship, s visual weights in one-to-one correspondence with s sub-regions in the virtual environment, each of the s visual weights being a visual weight of a corresponding current sub-region relative to a center point of a candidate region, and s being an integer greater than or equal to n;
screening out a target region from the candidate region, the candidate region comprising the s sub-regions, an aspect ratio of the candidate region being the first aspect ratio, a center point of the target region being the same as the center point of the candidate region, an aspect ratio of the target region being the first aspect ratio, and a sum of visual weights of sub-regions in the target region being the first value; and
determining, based on a size of the target region, that the virtual camera is located at the first height,
the weight association relationship being configured for indicating a negative correlation between a visual weight and an offset distance, and the offset distance being a distance between a current sub-region corresponding to the visual weight and the center point of the candidate region.

14. The computer device according to claim 13, wherein a terminal displaying the first observation picture has a control permission or a spectator permission for a first virtual character in the virtual environment, and the weight association relationship comprises a first sub-relationship and a second sub-relationship; and
the determining, based on a weight association relationship, s visual weights in one-to-one correspondence with s sub-regions in the virtual environment comprises:
determining, based on the first sub-relationship, s1 visual weights in one-to-one correspondence with s1 sub-regions; and
determining, based on the second sub-relationship, s2 visual weights in one-to-one correspondence with s2 sub-regions,
the first sub-relationship being configured for indicating a negative correlation between a visual weight and the offset distance when the offset distance exceeds a distance threshold; the second sub-relationship being configured for indicating a negative correlation between the visual weight and the offset distance when the offset distance does not exceed the distance threshold; and the distance threshold being a maximum observation distance of the first virtual character in the virtual environment, s being a sum of s1 and s2, and s1 and s2 being both positive integers.

15. The computer device according to claim 14, wherein the s sub-regions comprise a first sub-region, a second sub-region, and a third sub-region; both a first offset distance and a second offset distance in one-to-one correspondence with the first sub-region and the second sub-region do not exceed the distance threshold, and a third offset distance corresponding to the third sub-region exceeds the distance threshold; and
a difference between the first offset distance and the second offset distance is a first difference value, a difference between the second offset distance and the third offset distance is a second difference value, and the first difference value is equal to the second difference value; and a difference between a first visual weight corresponding to the first sub-region and a second visual weight corresponding to the second sub-region is a third difference value, a difference between the second visual weight corresponding to the second sub-region and a third visual weight corresponding to the third sub-region is a fourth difference value, and the third difference value is less than the fourth difference value.

16. The computer device according to claim 10, wherein both the first aspect ratio and the second aspect ratio are not within a preset ratio range, the preset ratio range is determined based on a preset screen ratio and a tolerance parameter; and the preset screen ratio is an initial imaging ratio of the virtual camera in a development process in which an application provides the virtual environment.

17. The computer device according to claim 16, wherein the method further comprises:
generating a third observation picture for a third screen of a third terminal having a third aspect ratio by stretching a fourth observation picture having an aspect ratio having the preset screen ratio to be an observation picture having the third aspect ratio,
the fourth observation picture being an observation picture of the virtual environment captured by the virtual camera based on the initial imaging ratio; and the third aspect ratio being within the preset ratio range.

18. The computer device according to claim 10, wherein
the virtual environment is provided by at least one of a multiplayer online battle arena (MOBA) game and a real-time strategy (RTS) game; and/or, the first observation picture and the second observation picture are pictures obtained by observing the virtual environment at a top view.

19. A non-transitory computer-readable storage medium having executable instructions stored therein, the executable instructions, when loaded and executed by a processor of a computer device, causing the computer device to implement a method for generating an observation picture of a virtual environment including:
generating a first observation picture by using a first virtual camera located at a first height in the virtual environment for a first screen of a first terminal having a first aspect ratio, the first observation picture being an observation result of a first region in the virtual environment, and an area of the first region in the virtual environment being a first area; and
generating a second observation picture by using a second virtual camera located at a first height in the virtual environment for a second screen of a second terminal having a second aspect ratio, the second observation picture being an observation result of a second region in the virtual environment, and an area of the second region in the virtual environment being a second area, wherein:
a ratio between the first aspect ratio and the second aspect ratio being a first ratio, a ratio between the first area and the second area being a second ratio, and the first ratio being greater than the second ratio; and the first aspect ratio being greater than the second aspect ratio, and the first height being less than the second height.

20. The non-transitory computer-readable storage medium according to claim 19, wherein the first region comprises n sub-regions, and the n sub-regions are in one-to-one correspondence with n visual weights; and a sum of the n visual weights is a first value; and
an i^{th} visual weight in the n visual weights is negatively correlated with an i^{th} distance, and the i^{th} distance is a distance between an i^{th} sub-region in the n sub-regions and a center point of the first region; and n is an integer greater than 1, and i is a positive integer not greater than n.
